(19) United States
(12) Patent Application Publication
(10) Pub. No.: US 2020/0016802 A1
(43) Pub. Date: Jan. 16, 2020

(54) METHOD FOR PROCESSING FILMS, AND A FEED DEVICE, AN INJECTION MOLD AND A SYSTEM

(71) Applicant: LEONHARD KURZ Stiftung & Co. KG, Fürth (DE)

(72) Inventors: Martin HAHN, Herrieden (DE); Helmut HÖGL, Nurnberg (DE); Christoph STUHLINGER, Wendelstein (DE)

(21) Appl. No.: 16/335,531

(22) PCT Filed: Sep. 27, 2017
(86) PCT No.: PCT/EP2017/074453

§ 371 Date: Mar. 21, 2019

(30) Foreign Application Priority Data
Sep. 27, 2016 (DE) 10 2016 118 259.1

(51) Int. Cl. B29C 45/14; B29C 45/76

(52) U.S. Cl. CPC B29C 45/14016; B29C 45/76; B29C 2045/14918; B29C 2945/76167; B29L 2031/3005; B29C 2945/76461; B29C 2945/76545; B29C 2945/76772; B29C 2945/76294

(57) ABSTRACT

A method for processing film webs including providing at least two film webs that are arranged next to one another in a direction substantially perpendicular to the feed direction and have motifs, delivering the at least two film webs that are arranged next to one another into the injection mold and aligning the at least two film webs that are arranged next to one another in such a way that each motif is arranged register-accurate with respect to a respective cavity. A feed device includes at least two film pay-off reels and at least two film take-up reels, wherein one film pay-off reel and one film take-up reel is assigned to each film web. An injection mold for back injection molding at least two film webs having motifs has at least two cavities.

The invention relates to a method for processing films, in particular IMD films, and a feed device, an injection mold and a system.

For the production-integrated surface decoration of plastic parts, plastic films or layers that can be transferred from a carrier film are used. Plastic parts decorated in this way are used, for example, in automobile manufacturing for automobile interior parts such as door trims, Instrument panel trims and center console covers, in the field of consumer electronics for decorative trims on televisions or in the telecommunications field for housing shells for portable devices such as mobile telephones. In the case of the surface decoration of plastic parts using IMD technology (IMD=in-mold decoration), a plastic film is introduced into a cavity of a mold and then back injection molded with an Initially flowable filling medium. The film is usually transported into the mold automatically by means of a feed device. After the back injection molding, the carrier film can be peeled off the layers transferred onto the solidified filling medium.

Thus, for example in JP 62128720 A an IMD film is disclosed, which is guided into an injection mold by means of a feed device. In the case of individual image representations in the area of the decorative film to be laminated on, the IMD film is also positioned correctly in relation to the injection mold on the IMD film via sensors and position markings before the injection mold is closed and the IMD film is back injection molded with the hot sprayed plastic material.

To increase the number of units, the use of several cavities lying one behind another is known, wherein the positioning of the film becomes more complicated with the number of cavities arranged one behind another.

The object of the invention is now to provide an improved method for processing films as well as an improved feed device and an improved injection mold.

This object is achieved by a method for processing film webs, in particular IMD film webs, by means of a feed device with a feed direction and an injection mold having at least two cavities, wherein the method comprises the following steps: providing at least two film webs that are arranged next to one another in a direction substantially perpendicular to the feed direction and have motifs, delivering the at least two film webs that are arranged next to one another into the injection mold and aligning the at least two film webs that are arranged next to one another in such a way that each motif is arranged register-accurate with respect to a respective cavity. The method steps are preferably carried out corresponding to the above-named sequence. This object is further achieved by a feed device with a feed direction for feeding at least two film webs that are arranged next to one another in a direction substantially perpendicular to the feed direction and have motifs, comprising at least two film pay-off reels and at least two film take-up reels, wherein one film pay-off reel and one film take-up reel is assigned to each film web. This object is also achieved by an injection mold for back injection molding at least two film webs having motifs, wherein, in top view, the film webs are arranged next to one another in a direction substantially perpendicular to a feed direction of the film webs, wherein the injection mold has at least two cavities. Further, this object is also achieved by a system comprising a feed device, in particular according to one of claims 15 to 19, and an injection mold, in particular according to one of claims 20 to 25.

The advantage is hereby obtained that, despite an increase in the number of units, the positioning of the motifs located on the films in the injection molds is possible more easily and more precisely, without high tolerances arising. As a whole, the number of units can hereby be further increased, while wastage is at the same time reduced. This leads to a reduction in unit costs.

By feed direction is meant here the direction in which the film webs are guided from the film pay-off reels in the direction of the film take-up reels. It is possible, for example, that the film pay-off reels and the film take-up reels are arranged in a plane spanned by an x and y co-ordinate, with the result that the film webs running between the film pay-off and film take-up reels run in particular along the y axis. It is thus possible, for example, that the film webs are fed from top to bottom, i.e. in particular that the feed direction runs vertically, or that the film webs are fed from right to left or from left to right, i.e. In particular that the feed direction runs horizontally.

By substantially perpendicular is meant here an angle range between 80° and 100°, preferably between 85° and 95°, in particular 90°.

By top view is meant here a top view onto the two film webs that are arranged next to one another. It is thus possible that the top view is effected from the surface normals, therefore a direction perpendicular to a plane spanned by the two film webs that are arranged next to one another and/or in the closing and opening direction of the injection mold. If, for example, the two film webs that are arranged next to one another lie in a plane spanned by an x and y co-ordinate, the direction of the top view is a z direction perpendicular to the plane spanned by the x and y co-ordinate.

A motif can be, for example, a graphically formed outline, a figural representation, an image, a visually recognizable design element, a symbol, a logo, a portrait, a pattern, an alphanumeric character, a text, a color design and the like.

The film webs are preferably formed such that the motifs are each surrounded by a motif-free area. In particular, the motif-free area is in each case formed between the motifs and the side edges of the film webs and/or between the motifs. The motif-free area therefore preferably forms a frame, in particular a circumferential frame, around a respective motif. The width of the motif-free area is preferably between 10 mm and 550 mm, in particular between 25 mm and 300 mm.

The motif-free area preferably has a first partial area and a second partial area, wherein in particular the first partial area makes space for the positioning of a clamping device, in particular a clamp frame, and/or the second partial area makes space for the positioning of register marks.

It is possible here that the first partial area is arranged directly adjacent to the motif, in particular that the first partial area is arranged directly adjoining the motif, in order to achieve the fixing of the film webs by means of a clamping device in direct proximity to the motif, with the result that interference factors such as film stretching, wrinkling etc. are minimized. The second partial area and the motif are preferably arranged spaced apart from each other. In particular, the first partial area lies between the motif and the second partial area. The register marks provided in the second partial area can hereby be detected more easily by sensors or easier positioning of the sensors is possible.

Alternatively, however, the reverse sequence is also possible, i.e. the second partial area for the register marks is directly adjacent to the motif, in particular arranged directly adjoining the motif, and the first partial area for fixing the film by means of a clamping device is provided further out relative thereto.

The first partial area preferably has a width between 5 mm and 500 mm, in particular preferably between 15 mm and 200 mm. The second partial area preferably has a width between 5 mm and 50 mm, in particular preferably between 15 mm and 30 mm.

Thus, it is further possible that a film web has different motifs, in particular successive motifs in the feed direction. It is further advantageous that the two film webs that are arranged next to one another have matching motifs. However, the film webs can also have motifs that differ from each other.

The motifs can preferably be both individual images and endless motifs. The motifs preferably overlap the cavities. Thus, it is possible that the motifs are at least 1% larger than the cavities. In particular, the motifs overlap the cavities in every direction, preferably between 1 mm and 20 mm. Through this slight overlapping of the motifs it is achieved that little varnish or paint is present outside the cavities, with the result that damaging adhesions and contamination on the injection mold can be prevented.

By registration-accurate or register-accurate is meant a positional accuracy of two or more elements, here in particular of the motifs of the film webs and of the cavities, relative to each other. The registration accuracy or register accuracy is to vary within a predetermined tolerance and to be as low as possible. At the same time, the registration accuracy of several elements relative to each other is an important feature in order to increase the process stability. The positionally accurate positioning can be effected in particular by means of sensorily, preferably optically detectable registration marks or register marks. These register marks can either represent specific separate elements or areas or layers or themselves be part of the elements to be positioned, in particular of the film webs.

Preferred embodiments are referred to in the dependent claims.

It is advantageous that the at least two film webs that are arranged next to one another are provided, delivered and/or aligned independently of one another. Thus, it is possible that the feed device is formed such that the at least two film webs that are arranged next to one another are provided, delivered and/or aligned independently of one another. A high register accuracy of the motifs with respect to the cavities is hereby achieved for each film web. Thus, it is possible to react individually to motifs of the film webs that differ from each other and/or to different tolerances of the motifs of the film webs. The register accuracy is hereby further increased.

However, it is also possible that the at least two film webs that are arranged next to one another are provided, delivered and/or aligned synchronously with one another.

The alignment and/or delivery of the at least two film webs that are arranged next to one another is advantageously effected in each case with the help of at least one register mark.

The register marks are preferably formed such that by means of these register marks the positions in the feed direction and/or in a direction perpendicular to the feed direction of the two film webs that are arranged next to one another can be determined.

At least one register mark is preferably assigned to each motif of the two film webs that are arranged next to one another. Thus, it is possible that a single register mark is assigned to a motif with the result that by means of it the position of the assigned motif in the feed direction and in a direction perpendicular to the feed direction can be determined. Further, it is also possible that two register marks are assigned to one motif with the result that by means of one of the register marks the position of the assigned motif in the feed direction can be determined and by means of the other register mark the position of the assigned motif in a direction perpendicular to the feed direction can be determined.

Further, it is also expedient that the distance from register mark to the assigned motif is as small as possible, in particular that the distance is between 5 mm and 500 mm, in particular between 15 mm and 200 mm. The positioning accuracy is hereby further increased.

The positional relationship between at least one register mark and the assigned motif is preferably the same for all motifs of each of the two film webs that are arranged next to one another.

The register marks are advantageously arranged in each case on at least one side edge of the two film webs that are arranged next to one another in the feed direction. The register marks are expediently arranged in each case on both side edges of the two film webs that are arranged next to one another in the feed direction. Ideally the register marks are arranged equally on both side edges. It is hereby achieved that, when inserting the film webs into the feed device or into the system or into the injection mold, closer attention need not be paid to which film web has to be inserted on which side. Two film designs are thus not necessary. The two film webs that are arranged next to one another are preferably formed mirror-symmetrically.

The two film webs that are arranged next to one another can also have register marks on both or on opposite sides.

The register mark is not tied to a fixed geometry. Advantageously, register marks are rectangular. It is further possible that the register mark is formed as a dot, cross mark, arrow, polygon or square. Furthermore, it is possible that the register mark is formed as a strip, which extends substantially along the film webs, in particular in the feed direction.

The alignment and/or delivery of the at least two film webs that are arranged next to one another is preferably effected in each case with the help of at least one motif of each of the at least two film webs that are arranged next to one another. A register-accurate arrangement of the motifs with respect to the cavities is hereby achieved without the use of register marks being required.

Since the motifs themselves almost serve as register marks, possible stretching of the film webs between register mark and motif does not play a role. Thus, film webs without register marks can also be processed. Further, it is also possible that film webs both with and without register marks are processed.

The feed device and/or the system expediently has at least one sensor for detecting at least one register mark and/or at least one motif. It is hereby possible that the sensor is a transmitted light and/or reflected light sensor. The transmitted light sensor is preferably a fork light barrier and the reflected light sensor a reflective sensor.

The at least one sensor advantageously has a distance from at least one of the cavities between 5 mm and 200 mm, preferably between 15 mm and 50 mm. The positioning accuracy of the motifs relative to the cavity can be further increased by this smallest possible distance since an uncontrollable influence of the film twisting can be kept as small as possible.

Further, it is possible that the at least one sensor is arranged in such a way that it detects substantially areas of a film web, in particular edge areas of a film web, wherein, in top view, the areas in each case lie on a side of one film web facing away from the other film web. A disruptive influence of the sensors, in particular with respect to the injection mold, is hereby prevented. In particular, the sensors are hereby prevented from colliding with the injection mold when the injection mold Is opened and closed.

The delivery and/or the alignment of the at least two film webs that are arranged next to one another preferably comprise a first and a second phase. The phases differ from each other in particular in their film transport average speed and/or their film transport distance. By this means, on the one hand the motif is quickly introduced into the area of the cavity and on the other hand an exact positioning within the cavity is achieved, with the result that the process times can be further reduced.

Expediently, the delivery forms the first phase and the alignment forms the second phase. In particular, the delivery represents the transport of the two film webs that are arranged next to one another in the feed direction into the injection mold, wherein the direction perpendicular to the feed direction plays a subordinate role or none. The alignment represents, in particular, the register-accurate arrangement of the motifs of the two films that are arranged next to one another with respect to the cavities, wherein in addition to the alignment in the feed direction an alignment in a direction perpendicular to the feed direction also plays a role or is carried out.

Further, it is advantageous if in the first phase the at least two films that are arranged next to one another are aligned at a higher film transport average speed and/or over a longer film transport distance than in the second phase.

It is also possible that in the first phase the film transport average speed is between 1 mm/s and 1000 mm/s, preferably between 250 mm/s and 750 mm/s, further preferably between 450 mm/s and 550 mm/s, and/or the film transport distance is between 10 mm and 5000 mm, preferably between 1500 mm and 3500 mm, further preferably between 2500 mm and 3000 mm.

Moreover, it is preferred that in the second phase the film transport average speed is between 1 mm/s and 100 mm/s, preferably between 5 mm/s and 50 mm/s, and/or the film transport distance is between 3 mm and 50 mm, preferably between 3 mm and 10 mm. This film transport distance in the second phase is dependent in particular on the size of the register mark. The register marks preferably have a size of from approximately 3 mm×3 mm to 20 mm×20 mm, in particular of from approximately 3 mm×3 mm to 10 mm×10 mm. In the case of a strip-shaped “endless” register mark, the width is preferably approximately 3 mm to 20 mm, in particular approximately 3 mm to 10 mm. By strip-shaped “endless” register mark is meant in particular register marks which extend as a strip substantially along the film webs, in particular in the feed direction. The length and width of the register marks can also differ in each case, for example a register mark can also have a size of 10 mm×8 mm.

It is particularly preferred if, when the at least one register mark and/or the at least one motif is detected, there is a changeover from the first to the second phase. It can hereby be achieved that the first phase can be negotiated quickly without high equipment costs. The distance covered in the first phase can, in particular, contain a blind section. Here the blind section is preferably shorter than the film transport distance of the first phase. In particular, the blind section begins at the start of the film transport distance of the first phase. However, the blind section preferably ends before the end of the film transport distance of the first phase. A reliable recognition of the next register mark at the end of the first phase is hereby made possible.

As soon as a register mark and/or motif is recognized, there is preferably a changeover into the second phase and thus into the more exact positioning accuracy and the film transport speed is reduced. Here the second phase begins in particular at a first-recognized outer edge of a register mark and ends in particular at a last-recognized outer edge of a register mark. This last-recognized outer edge of the register mark can preferably be detected with particular accuracy because of the low film transport speed.

It is further possible that between the first and the second phase there is a transition phase, in particular for speeding up and/or for slowing down the film transport average speed.

By a blind section is preferably meant a predefined area between two register marks and/or motifs, in which a sensor does not interpret possible signals as register marks and/or position information but ignores or disregards them.

Thus, it is possible that decorative elements or film designs or also other optical features present in the blind section are not detected by the sensor. Thus, it is possible, for example, that the two film webs that are arranged next to one another are moved in the blind section at a high film transport average speed until a first register mark edge of the at least one register mark and/or a first motif edge of the at least one motif is detected. After the first register mark edge and/or the first motif edge is detected there is a changeover into a slow film transport average speed. Once a second register mark edge of the at least one register mark and/or a second motif edge of the at least one motif s reached or detected the film web feed is stopped.

It is further possible that, after the film web feed is stopped, the film webs are moved forward and/or back by a predetermined amount. On the one hand a precise and efficient adjustment can hereby be effected and on the other hand manufacturing tolerances of the film webs can thus be reacted to individually. The predetermined amount can be determined both manually and automatically, in particular by a control device.

It is expedient if the alignment of the at least two film webs that are arranged next to one another is effected with the help of a comparison of the position of the at least one register mark and/or the position of the at least one motif with the predetermined position of the cavities. By predetermined is meant here the fixed arrangement of the cavity in the injection mold. The predetermined position of the cavities can be established either by detection of a fixed component geometry, for example an outer or inner edge or the like, or by detection of a freely positionable element on the cavity, for example a projected laser light spot or a label or a similar element, which can also be repositioned if necessary or expedient.

It is advantageous that, after register-accurate arrangement of each motif with respect to a respective cavity, a release signal is generated in each case. It is hereby ensured that back injection molding of the motifs is not actually effected until all the motifs to be back injection molded of the two film webs that are arranged next to one another are in each case aligned register-accurate in relation to a cavity. Further, for all produced molded plastic parts, low tolerance values are hereby achieved and thus extremely low wastage. Thus, it is possible that the release signal is only generated in the case of deviations of less than ±0.1 mm, preferably less than ±0.05 mm, in the feed direction and/or in a direction perpendicular to the feed direction for each motif that is aligned with respect to a cavity.

The deviations preferably comprise several different tolerances, in particular mechanical tolerances of the feed device, production tolerances in the production of the film webs, in particular pressure tolerances and material properties of the film webs, in particular the stretch coefficient thereof.

Expediently, the method further comprises at least one of the following steps, which is carried out in particular after generation of the release signals:
closing the injection mold
back injection molding the motifs, that are arranged register-accurate with respect to the cavities, of the at least two film webs that are arranged next to one another with a plastic compound at least in areas
opening the injection mold
peeling a carrier layer of the at least two film webs that are arranged next to one another off the back-injection-molded motifs
removing a molded plastic part.

Preferably the film webs are transfer films, which each comprise a carrier layer and a transfer ply. The transfer ply can be detached from the carrier layer.

It is also possible for the film webs to be laminating films. The injection mold preferably comprises, in particular when the film webs are realized as laminating films, at least one punching tool, in particular for punching out film areas assigned to the respective cavity from the at least two film webs that are arranged next to one another. Here, the film areas assigned to the respective cavity preferably each comprise one motif.

Advantageously, in the processing of laminating films, a punching tool is preferably provided in or on the injection mold, wherein, by means of the punching tool, the laminating films are punched out in such a way that at least one film area assigned to the respective cavity can be detached from the otherwise closed film webs. It is advantageous here if a punching contour of the punching tool follows the outer contour of the respective cavity at least in areas and if a punching tool is assigned to each cavity.

Further, it is also possible to process different film webs, therefore, for example, at least one transfer film web and at least one laminating film web in different cavities of the injection mold. Thus, it is possible that at least one of the at least two film webs that are arranged next to one another is a transfer film and a second of the at least two film webs that are arranged next to one another is a laminating film.

It is preferably specifically an injection mold which has at least two cavities. Preferably at least one cavity is assigned to each film web. If the injection mold has two cavities, for example, which in particular in top view are arranged in a direction substantially perpendicular to the feed direction, precisely one cavity Is assigned to each film web. It is further possible that the injection mold has two or more cavities, which in top view are arranged in a direction substantially perpendicular to the feed direction.

Expediently, the injection mold has one or more further cavities in the feed direction. It is hereby achieved that, for each of the at least two film webs that are arranged next to one another, several motifs can be arranged register-accurate, in particular simultaneously, with respect to a respective cavity. Thus, it is also possible that at least two cavities, which are arranged one behind the other in the feed direction, are assigned to each film web.

The cavities are advantageously arranged according to a grid, in particular according to a one- or two-dimensional grid. Here the grid width in the feed direction is preferably between 1 mm and 100 mm, in particular preferably between 10 mm and 40 mm. Further, the grid width perpendicularly to the feed direction is preferably between 10 mm and 2000 mm, in particular preferably between 100 mm and 1000 mm.

Further, it is possible that the injection mold has a clamping device, in particular a clamp frame, and/or vacuum suction. Fixing of the motifs of the at least two film webs that are arranged next to one another in the cavities, in particular with a tolerance of ±0.05 mm, preferably t 0.02 mm, in particular preferably ±0.01 mm, in the feed direction and/or in a direction perpendicular to the feed direction is hereby achieved.

Expediently, the feed device has at least one adjustment device, in particular for the alignment of the two film webs that are arranged next to one another and have motifs. Advantageously, the feed device has two adjustment devices, wherein in each case one adjustment device is assigned to one film web.

The adjustment device preferably comprises at least one stepper motor, in particular for the alignment of the two film webs that are arranged next to one another or for the alignment of one of the two film webs that are arranged next to one another.

Advantageously, the adjustment device comprises a first stepper motor and a second stepper motor, wherein the first stepper motor is formed for the alignment of one or both film webs in the feed direction and the second stepper motor is formed for the alignment of one or both film webs in a direction perpendicular to the feed direction.

Expediently, the stepper motor has a minimum step size of 0.005 mm, preferably of 0.001 mm. Further, it is expedient that the stepper motor has a maximum speed of 2000 mm/s. An efficient and precise alignment of the two film webs that are arranged next to one another and have motifs is hereby made possible.

Alternatively to the stepper motor, the adjustment device can also have one or more servomotors for the adjustment of the two film webs in the feed direction and/or perpendicular to the feed direction. The servomotor or servomotors preferably have a maximum speed of 2000 mm/s. A servomotor can position very precisely independently of a fixed step length, thus reach fixed positions, and/or react very precisely to control signals.

Depending on the formation of the motifs on the film webs it is possible to dispense with at least one of the two adjustments of the film webs in the feed direction or perpendicular to the feed direction.

For example, the motif can have several parallel strips running perpendicular to the feed direction, which in this direction are larger than the respective cavity and in particular run from film edge to film edge. In this example, the adjustment perpendicular to the feed direction could be dispensed with because in this direction the motif is practically “endless”, i.e. is present in particular without interruption or continuously. In contrast, in this example the adjustment in the feed direction is necessary because the register accuracy of the motif relative to the respective cavity is required in this direction.

For example, the motif can have several parallel strips running in the feed direction, which in this direction are larger than the respective cavity. In this example, the adjustment in the feed direction could be dispensed with because in this direction the motif is practically “endless”, i.e. Is present in particular without interruption or continuously. In contrast, in this example the adjustment perpendicular to the feed direction is necessary because the register accuracy of the motif relative to the respective cavity is required in this direction.

For example, the motif can have an area which is smaller in all directions than the respective cavity, a circular or also rectangular area, for example. In this example the respective film web would have to be adjusted in the feed direction and also perpendicular to the feed direction because the register accuracy of the motif relative to the respective cavity is required in both directions.

Further, it is also possible that the at least one adjustment device is part of the film pay-off reels and/or of the film take-up reels. The adjustment devices and/or film pay-off reels and/or film take-up reels are preferably designed in such a way that film webs with a width between 10 mm and 2000 mm, preferably between 100 mm and 1000 mm, can be processed with them.

It is advantageous if the feed device and/or the system has at least one control device. The control device of the feed device and/or of the system is preferably designed to control the feed of the at least two film webs that are arranged next to one another, in particular to control the feed independently of each other of the at least two film webs that are arranged next to one another.

Expediently, the control device of the system is designed in such a way that it controls the injection mold. Further, it is also possible that the control device is formed in such a way that, after register-accurate arrangement of each motif with respect to a respective cavity, the control device actuates the injection mold, whereby in particular the injection mold is closed. It is advantageous here if the actuation does not take place until a release signal has been generated in each case after register-accurate arrangement of each motif with respect to a respective cavity.

Embodiment examples of the invention are explained below by way of example with the aid of the accompanying figures, which are not to scale.

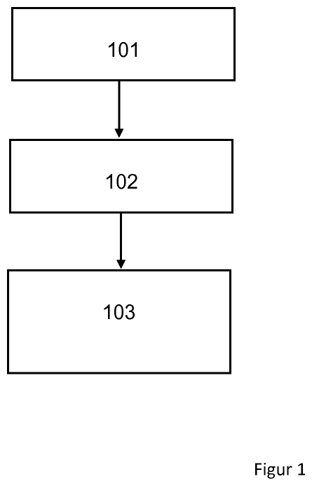

FIG. 1 shows a flow diagram of a method for processing film webs

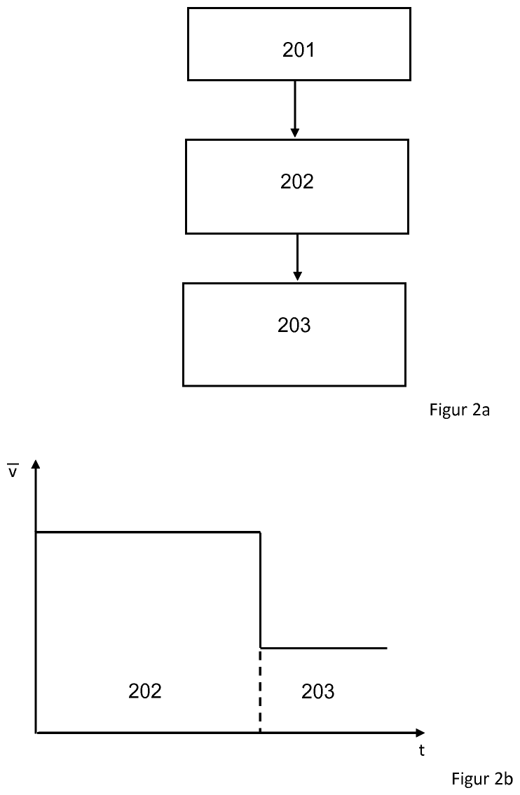

FIG. 2a shows a flow diagram of a method for processing film webs

FIG. 2b shows a diagram which specifies the film transport average speeds

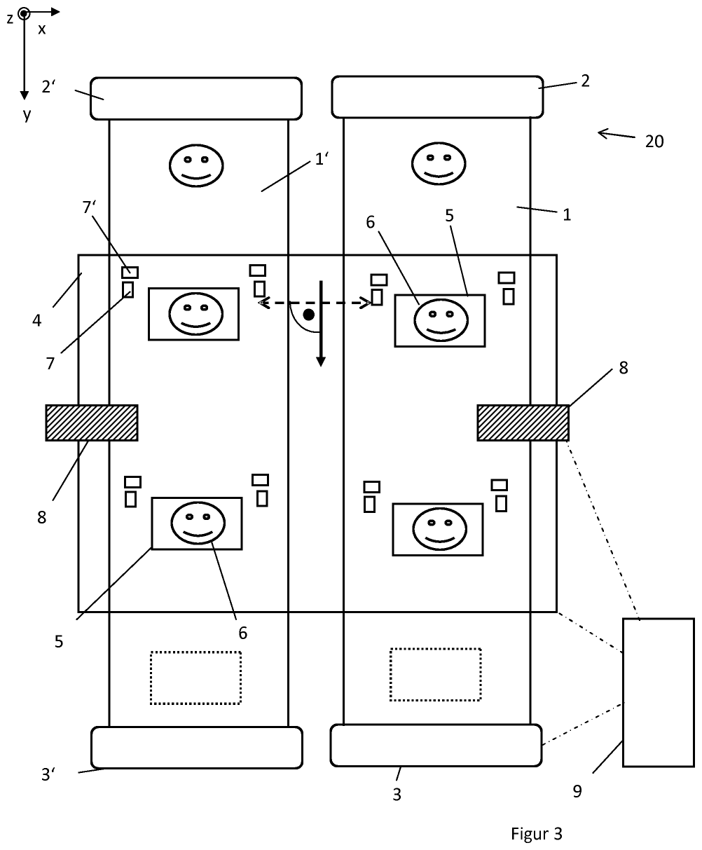

FIG. 3 shows a schematic top view onto a system

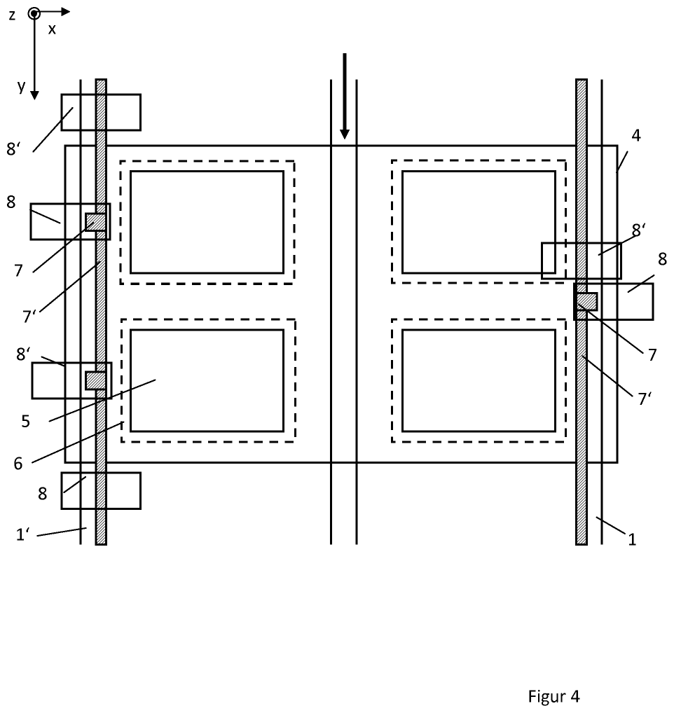

FIG. 4 shows a schematic top view onto a section of a system

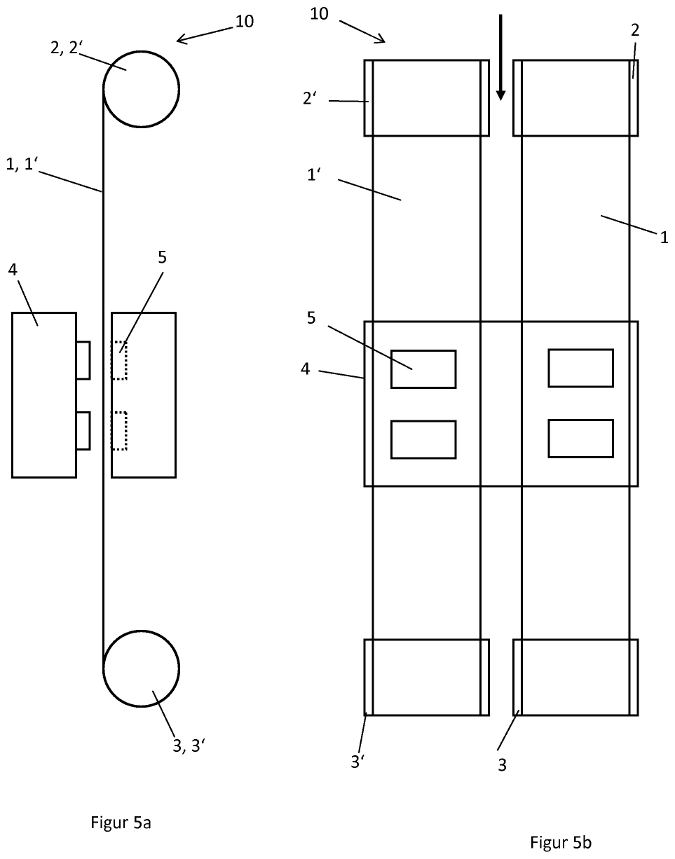

FIG. 5a shows a schematic side view of a system

FIG. 5b shows a schematic top view onto a system

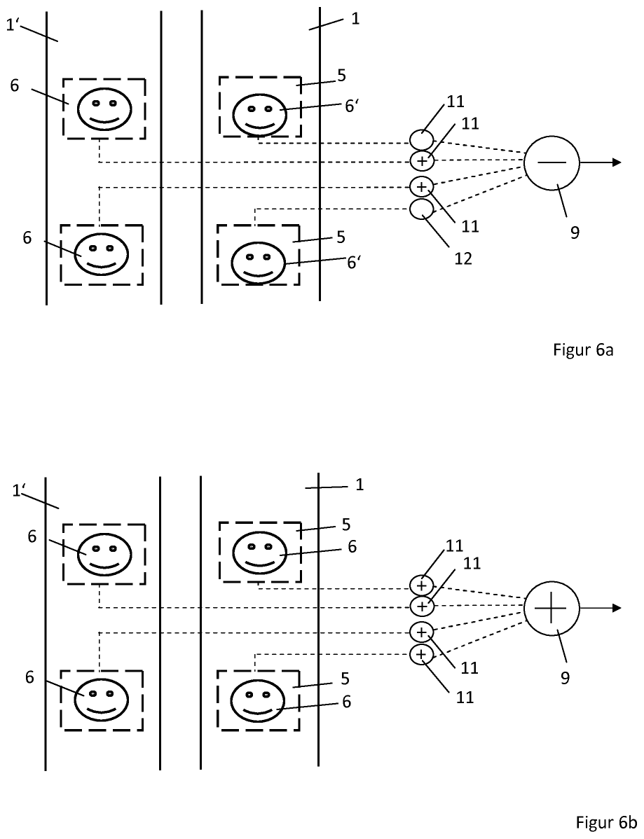

FIGS. 6a, 6b show schematic representations of the alignment of film webs

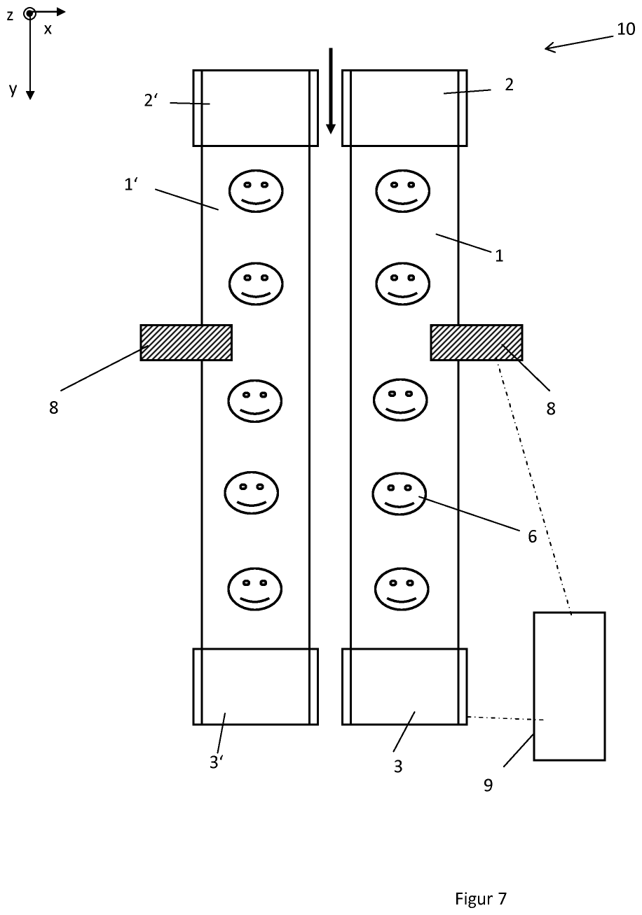

FIG. 7 shows a schematic view of a feed device

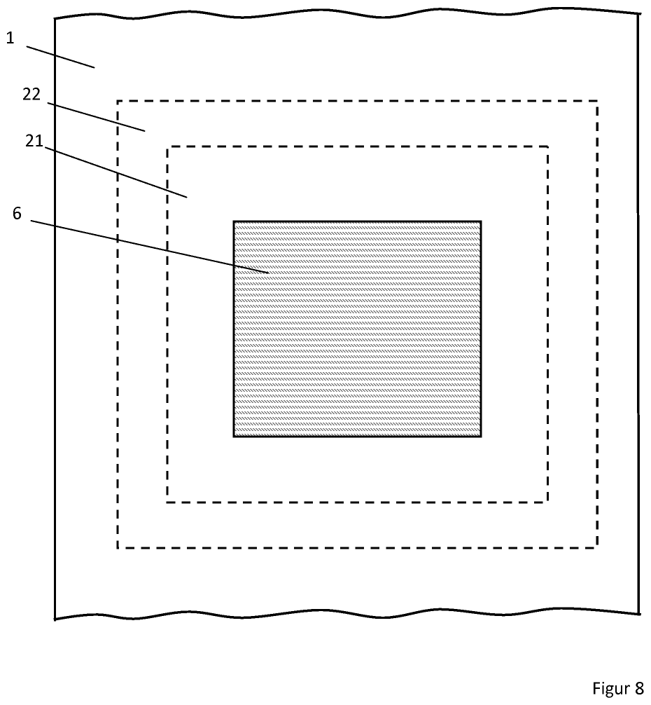

FIG. 8 shows a schematic top view onto a motif of a film web

FIG. 1 shows a flow diagram of a method for processing film webs, in particular IMD film webs, comprising a feed device with a feed direction.

In a first step 101, two film webs are provided that are arranged next to one another in a direction substantially perpendicular to the feed direction and have motifs.

The film webs can preferably have a single- or multilayer structure. Further, the film webs can be laminating films or transfer films.

The film webs preferably have a width between 10 mm and 2000 mm, in particular preferably between 100 mm and 1000 mm. Here, the width is preferably determined in a direction perpendicular to the feed direction. Further, the film webs in particular have an overall length of from 100 m to 1000 m, in particular of from 300 m to 500 m. The film webs further preferably have an overall thickness between 5 μm and 1000 μm.

The film webs preferably comprise a carrier layer. The carrier layer is preferably a PET, PEN, OPP, BOPP, PE or cellulose acetate film with a thickness between μm and 250 μm.

Further, the film webs can have one or more decorative layers. The one or more decorative layers are preferably formed patterned for the formation of the motifs. The decorative layers are advantageously selected from the group: printed layer, vapor-deposited layer, electroplated layer, replication varnish layer, reflective layer, layer containing optically variable pigments, metallic pigments, thin-film layer structures, volume hologram layer, hologram layer.

The replication varnish layer preferably consists of a thermoplastic varnish into which a surface structure is molded by means of heat and pressure by the action of a stamping tool. Further, it is also possible that the replication varnish layer is formed by a UV-crosslinkable varnish and the surface structure is molded into the replication varnish layer by means of UV replication. The surface structure is molded onto the uncured replication varnish layer by the action of a stamping tool and the replication varnish layer is cured directly during or after the molding by Irradiation with UV light.

The replication varnish layer preferably has a layer thickness between 0.2 μm and 2 μm. The surface structure molded into the replication varnish layer is preferably a diffractive surface structure, for example a hologram, Kinegrameor another optically diffractive active grating structure. Such surface structures typically have a spacing of the structural elements in the range of from 0.1 μm to 4 μm. It is further also possible that the surface structure is a zero-order diffraction structure, a blazed grating, a preferably linear or crossed sinusoidal diffraction grating, a linear or crossed single- or multi-step rectangular grating, an asymmetrical saw-tooth relief structure, a light-diffracting and/or light-refracting and/or light-focusing micro- or nanostructure, a binary or continuous Fresnel lens, a binary or continuous Fresnel freeform surface, a diffractive or refractive macrostructure, in particular lens structure or microprism structure, a mirror surface or mat structure, in particular an anisotropic or isotropic mat structure, or a combined structure of several of the above-named surface structures.

The reflective layer is preferably a metal layer made of chromium, gold, copper, silver or an alloy of such metals which is vapor-deposited in a layer thickness of from 1 nm to 150 nm under vacuum. It is also possible to produce the reflective layer from a varnish with electrically conductive metallic pigments, in particular to print and/or pour it on. Further, it is also possible that the reflective layer is formed by a transparent reflective layer, for example a thin or finely structured metallic layer or an HRI (high refractive index) or LRI (low refractive index) layer. Such a dielectric reflective layer consists, for example, of a vapor-deposited layer made of a metal oxide, metal sulfide, titanium oxide etc. with a thickness of from 10 nm to 150 nm. The reflective layer is preferably patterned, in particular for the formation of the motifs.

Further, the film webs can have a detachment layer. The detachment layer ensures that the one or more decorative layers can be separated from the carrier layer non-destructively.

The detachment layer preferably consists of waxes, polyethylene (PE), polypropylene (PP), cellulose derivatives or poly(organo)siloxanes. Above-named waxes can be natural waxes, synthetic waxes or combinations thereof. Above-named waxes are, for example, camauba waxes. Above-named cellulose derivatives are, for example, cellulose acetate (CA), cellulose nitrate (CN), cellulose acetate butyrate (CAB) or mixtures thereof. Above-named poly(organo)siloxanes are, for example, silicone binders, polysiloxane binders or mixtures thereof.

Furthermore, the film webs can also have one or more protective varnish layers. The protective varnish layer preferably has a layer thickness between 0.1 μm and 50 μm, in particular between 1 μm and 10 μm. The protective varnish layer is preferably a layer of PMMA, PVC and/or acrylate.

The protective varnish layer can be formed as a protective varnish made of a PMMA-based varnish. The protective varnish can also consist of a radiation-curing dual-cure varnish. This dual-cure varnish can be thermally pre-crosslinked in a first step during and/or after application in liquid form. Preferably, in a second step, in particular after the processing of the film webs formed as transfer film, the dual-cure varnish is radically post-crosslinked, in particular via high-energy radiation, preferably UV radiation. Dual-cure varnishes of this type can consist of various polymers or oligomers, which possess unsaturated acrylate or methacrylate groups. These functional groups can, in particular, be radically crosslinked with each other in the second step. For the thermal pre-crosslinking in the first step it is advantageous that at least two or more alcohol groups are also present in the case of these polymers or oligomers. These alcohol groups can be crosslinked with multifunctional isocyanates or melamine formaldehyde resins. Various UV raw materials such as epoxy acrylates, polyether acrylates, polyester acrylates and in particular acrylate acrylates preferably come into consideration as unsaturated oligomers or polymers. Both blocked and unblocked representatives based on TDI (TDI=toluene-2,4-diisocyanate), HDI (HDI=hexamethylene diisocyanate) or IPDI (IPDI=isophorone diisocyanate) can come into consideration as isocyanate. The melamine crosslinkers can be fully etherified versions, can be imino types or represent benzoguanamine representatives.

It can also be provided that the protective varnish layer is formed as a protective varnish made of a varnish based on PMMA (PMMA=polymethyl methacrylate), or a varnish based on a mixture of PVDF (PVDF=polyvinylidene fluoride) and PMMA, in particular with a layer thickness in the range of from 15 μm to 30 μm. These varnishes bring the mechanical brittleness needed for a transfer film and for being able to sufficiently precisely and cleanly stamp it out or separate it at the desired outer boundaries of the transferred areas of surface of the transfer plies.

Further, the film webs can have a base coat. The base coat is preferably an adhesive layer and/or adhesion-promoter layer.

It can be provided that the base coat is formed with a layer thickness in the range of from 1 μm to 5 μm. Raw materials coming into consideration for the base coat are PMMA, PVC, polyester, polyurethanes, chlorinated polyolefins, polypropylene, epoxy resins or polyurethane-polyols in combination with inactivated isocyanates. The base coats can also contain inorganic fillers.

A motif can be, for example, a graphically formed outline, a figural representation, an image, a visually recognizable design element, a symbol, a logo, a portrait, a pattern, an alphanumeric character, a text, a color design and the like.

In a second step 102, the delivery of the film webs that are arranged next to one another is effected into an injection mold having at least two cavities, in particular having at least two cavities that in top view are arranged in a direction substantially perpendicular to the feed direction.

In a third step 103, the alignment of the two film webs that are arranged next to one another is effected in such a way that each motif is arranged register-accurate with respect to a respective cavity.

The method steps are preferably carried out corresponding to the above-named sequence.

FIG. 2a shows a flow diagram of a method for processing film webs. In a first step 201, two film webs that are arranged next to one another and have motifs are provided.

In a second step 202, the film webs having the motifs are delivered in a first phase to the injection mold, in particular by means of a feed device.

In a third step 203, the film webs are aligned in such a way that each motif is arranged register-accurate with respect to a respective cavity.

The phases 202, 203 differ from each other in particular in their film transport average speed and/or their film transport distance.

FIG. 2b shows a diagram which specifies the film transport average speeds. As shown in FIG. 2b, in the first phase 202 the two films that are arranged next to one another are transported at a higher film transport average speed than in the second phase 203. In the second phase 203, with the low film transport average speed, the alignment of the motifs is effected in particular in the feed direction and/or in a direction perpendicular to the feed direction in relation to the respective cavities. It is hereby achieved that on the one hand the motif is quickly introduced into the area of the cavity and on the other hand an exact positioning within the cavity is achieved, with the result that the process times can be further reduced.

In the first phase 202 the film transport average speed here is in particular between 1 mm/s and 1000 mm/s, preferably between 250 mm/s and 750 mm/s, further preferably between 450 mm/s and 550 mm/s.

In the second phase 203 the film transport average speed is in particular between 1 mm/s and 100 mm/s, preferably between 5 mm/s and 50 mm/s.

Furthermore, it is also expedient that the film transport distances in the first phase 202 and second phase 203 differ from each other. It is advantageous here if the film transport distance of the first phase 202 is greater than in the second phase 203. In the first phase 202 the film transport distance is in particular between 10 mm and 5000 mm, preferably between 1500 mm and 3500 mm, further preferably between 2500 mm and 3000 mm.

In the second phase 203 the film transport distance is in particular between 3 mm and 50 mm, preferably between 3 mm and 10 mm. This film transport distance in the second phase 203 is dependent in particular on the size of the register mark. The register marks preferably usually have a size of from approximately 3 mm×3 mm to 20 mm×20 mm, in particular of from approximately 3 mm×3 mm to 10 mm×10 mm. In the case of a strip-shaped “endless” register mark, the width is preferably approximately 3 mm to 20 mm, in particular approximately 3 mm to 10 mm. The length and width of the register marks can also differ in each case, for example a register mark can also have a size of 10 mm×8 mm.

It is advantageous if the changeover between the first phase 202 and second phase 203 takes place when at least one register mark and/or the at least one motif is detected. It can hereby be achieved that the first phase 202 can be negotiated quickly without high equipment costs. The distance covered in the first phase 202 can, in particular, contain a blind section. Here the blind section is preferably shorter than the film transport distance of the first phase 202. In particular, the blind section begins at the start of the film transport distance of the first phase 202. However, the blind section preferably ends before the end of the film transport distance of the first phase 202. A reliable recognition of the next register mark at the end of the first phase 202 is hereby made possible. As soon as a register mark and/or motif is recognized, there is preferably a changeover into the second phase 203 and thus into the more exact positioning accuracy and the film transport speed is reduced. Here the second phase 203 begins in particular at a first-recognized outer edge of a register mark and ends in particular at a last-recognized outer edge of a register mark. This last-recognized outer edge of the register mark can preferably be detected with particular accuracy because of the low film transport speed.

FIG. 3 shows a schematic top view onto a system 10. The system 10 has a feed device for film webs 1, 1′. The feed device comprises two film pay-off reels 2, 2′ and two film take-up reels 3, 3′. As shown in FIG. 3, here in each case one film pay-off reel 2, 2′ and one film take-up reel 3, 3′ is assigned to a film web 1, 1′.

The feed device has a feed direction, which is represented in FIG. 3 by means of a thick arrow. By feed direction is meant the direction in which the film webs 1, 1′ are guided from the film pay-off reels 2, 2′ in the direction of the film take-up reels 3, 3′.

As is also shown in FIG. 3, the film pay-off reels 2, 2′ and the film take-up reels 3, 3′ are arranged in a plane spanned by an x and y co-ordinate, with the result that the film webs 1, 1′ running between the film pay-off 2, 2′ and film take-up reels 3, 3′ run in particular along the y axis, with the result that the feed direction also runs in the direction of the y axis.

By top view is meant here a top view onto the two film webs 1, 1′ that are arranged next to one another. In the top view, as shown in FIG. 3, the system is observed from the direction of the surface normals, therefore a direction perpendicular to a plane spanned by the two film webs 1, 1′ that are arranged next to one another and/or in the closing and opening direction of an injection mold 4. If the two film webs 1, 1′ that are arranged next to one another lie in a plane spanned by the x and y co-ordinate, as represented in FIG. 3, the direction of the top view is a z direction.

The injection mold 4 shown in FIG. 3 has the cavities 5. The injection mold 4 has at least two cavities 5 arranged in top view in a direction substantially perpendicular to the feed direction. The direction substantially perpendicular to the feed direction is represented in FIG. 3 with a dashed double arrow. Furthermore, the injection mold 4 can have one or more further cavities 5 in the feed direction. The injection mold 4 shown in FIG. 3 has two cavities 5 in the feed direction and two cavities 5 next to each other, therefore in a direction perpendicular to the feed direction. Thus, with the injection mold 4 shown in FIG. 3, four molded plastic parts can be produced at the same time.

The cavities 5 are advantageously arranged according to a grid, in particular according to a one- or two-dimensional grid. Here the grid width in the feed direction is preferably between 1 mm and 100 mm, in particular preferably between 10 mm and 40 mm. Further, the grid width perpendicular to the feed direction is preferably between 10 mm and 2000 mm, in particular preferably between 100 mm and 1000 mm.

Further, it is possible that the injection mold 4 has a clamping device, in particular a clamp frame, and/or vacuum suction. Fixing of the motifs 6 of the two film webs 1, 1′ that are arranged next to one another in the cavities 5, in particular with a tolerance of t 0.05 mm, preferably ±0.02 mm, in particular preferably ±0.01 mm, in the feed direction and/or in a direction perpendicular to the feed direction is hereby achieved.

The motifs 6 can preferably be formed larger than the cavities 5. The motifs 6 are preferably formed at least 1% larger than the cavities 5. Thus, it is possible that the motifs 6 each overlap a cavity 5 in every direction, preferably between 1 mm and 20 mm.

Further, it is also possible that the film web 1, 1′ and/or the film webs 1, 1′, unlike what is shown in FIG. 3, have different motifs 6. The motifs 6 can be both individual images and endless motifs.

The film webs 1, 1′ shown in FIG. 3 have register marks 7, 7′. The alignment of the film webs 1, 1′ is preferably effected with the help of the register marks 7, 7′.

The register marks 7, 7′ are preferably formed such that, by means of them, the positions in the feed direction and/or in a direction perpendicular to the feed direction of the two film webs 1, 1′ that are arranged next to one another can be determined.

As shown in FIG. 3, two register marks 7, 7′ are assigned to each motif 6. By means of one of the register marks 7 the position of the assigned motif 6 in the feed direction can hereby be determined and by means of the other register mark 7′ the position of the assigned motif 6 in a direction perpendicular to the feed direction can hereby be determined.

Further, it is also possible that a single register mark 7, 7′ is assigned to each motif 6 with the result that, by means of this register mark 7, 7′, the position of the assigned motif 6 in the feed direction and in a direction perpendicular to the feed direction can be determined.

It is expedient here that the distance of the register marks 7, 7′ from the assigned motif 6 is as small as possible, in particular that the distance is between 5 mm and 500 mm, in particular between 15 mm and 200 mm.

As shown in FIG. 3, the register marks 7, 7′ are advantageously arranged in each case on at least one side edge of the two film webs 1, 1′ that are arranged next to one another in the feed direction. It is also conceivable that the register marks 7, 7′ are arranged in each case on both side edges of the two film webs 1, 1′ that are arranged next to one another in the feed direction. The two film webs 1, 1′ that are arranged next to one another can also have register marks 7, 7′ on both or on opposite sides.

The register mark 7, 7′ is not tied to a fixed geometry. As shown in FIG. 3, the register marks 7, 7′ are advantageously rectangular. However, it is further also possible that the register mark 7, 7′ is formed as a dot, cross mark, arrow, polygon or square. Furthermore, it is possible that the register mark 7, 7′ is formed as a strip, which extends substantially along the film webs 1, 1′, in particular in the feed direction.

The system 10 further has at least one sensor 8 for detecting at least one register mark 7, 7′ and/or at least one motif 6.

It is hereby possible that the sensor 8 is a transmitted light and/or reflected light sensor. The transmitted light sensor is preferably a fork light barrier and the reflected light sensor a reflective sensor.

Advantageously, the at least one sensor 8 has a distance from the cavities 5 between 5 mm and 200 mm, preferably between 15 mm and 50 mm. The positioning accuracy of the motifs 6 can be further increased hereby.

As shown in FIG. 3, the at least one sensor 8 is arranged in such a way that it detects substantially areas of a film web 1, in particular edge areas of a film web 1, wherein, in top view, the areas in each case lie on a side of one film web 1 facing away from the other film web 1′. A disruptive influence of the sensors 8, in particular with respect to the injection mold 4, is hereby prevented. In particular, the sensors 8 are hereby prevented from colliding with the injection mold 4 when the injection mold 4 is opened and closed.

Further, as shown in FIG. 3, the system 10 has at least one control device 9. The control device 9 of the system 10 is preferably designed to control the feed of the two film webs 1, 1′ that are arranged next to one another. Expediently, the control device 9 of the system 10 is designed n such a way that it controls the injection mold 4. Further, it is also possible that the control device 9 is formed in such a way that, after register-accurate arrangement of each motif 6 with respect to a respective cavity 5, the control device 9 actuates the injection mold 4, whereby in particular the injection mold 4 is closed.

FIG. 4 shows a schematic top view onto a section of a system 10. As shown in FIG. 4, the film webs 1, 1′ have the register marks 7, 7′. The register mark 7 serves for detecting the position of the individual film webs 1, 1′ in the feed direction. The register mark 7′ serves for detecting the position of the individual film webs 1, 1′ in a direction perpendicular to the feed direction. As shown in FIG. 4, this means that the register mark 7 serves for detecting the position of the individual film webs 1, 1′ in the y direction and the register mark 7′ serves for detecting the position of the individual film webs 1, 1′ in the x direction. For this, as shown in FIG. 4, the system 10 has the sensors 8, 8′. Each sensor 8, 8′ is preferably assigned to one register mark 7, 7′. This preferably means that the sensor 8 serves for detecting the register mark 7 and the sensor 8′ serves for detecting the register mark 7′. As can be seen in FIG. 4, the sensors 8, 8′ can be arranged differently for detecting the register marks 7, 7′. For the sensors 8, 8′, openings can be present within the injection mold 4.

FIG. 5a shows a schematic side view of the system 10. FIG. 5b shows a schematic top view onto the system 10. The system 10 comprises the feed device for film webs 1, 1′. The feed device comprises the two film pay-off reels 2, 2′ and the two film take-up reels 3, 3′. As shown in FIG. 5b, here in each case one film pay-off reel 2, 2′ and one film take-up reel 3, 3′ is assigned to a film web 1, 1′.

The injection mold 4 shown in FIGS. 5a and 5b has the cavities 5. The injection mold 4 has two cavities 5 arranged in top view in a direction substantially perpendicular to the feed direction. Further, the injection mold 4 shown in FIGS. 5a and 5b has two cavities 5 in the feed direction. Thus, with the injection mold 4 shown in FIG. 5a and FIG. 5b, four molded plastic parts can be produced at the same time.

As can be seen in FIG. 5a, the mold has two mold halves. The film webs 1, 1′ having motifs 6 run between the two mold halves.

Expediently, after the register-accurate arrangement of the motifs 6 with respect to the respective cavities 5, at least one of the following steps is further effected, which is carried out in particular after generation of the release signals:
closing the injection mold 4
back injection molding the motifs 6, that are arranged register-accurate with respect to the cavities 5, of the film webs 1, 1′ that are arranged next to one another with a plastic compound at least in areas
opening the injection mold 4
peeling a carrier layer of the at least two film webs 1, 1′ that are arranged next to one another off the back-injection-molded motifs 6
removing a molded plastic part.

FIG. 6a shows a schematic representation of the alignment of film webs 1, 1′.

Thus, the two film webs 1, 1′ that are arranged next to one another and have the motifs 6, 6′ are shown in FIG. 6a. With respect to the design of the film webs 1, 1′ and the motifs 6, 6′, reference is made to the above statements.

FIG. 6a shows the generation of release signals, wherein a separate release signal 11 is assigned to each cavity 5. The release signals 11 are in each case not generated until the corresponding motif 6 is arranged register-accurate in the respective cavity 5.

Thus, it is possible that the release signal 11 is only generated in the case of deviations of less than ±0.1 mm, preferably less than ±0.05 mm, in the feed direction and/or in a direction perpendicular to the feed direction for each motif 6 that is aligned with respect to a cavity 5.

The deviations preferably comprise several different tolerances, in particular mechanical tolerances of the feed device, production tolerances in the production of the film, in particular pressure tolerances and material properties of the film, in particular the stretch coefficient thereof.

As shown in FIG. 6a, two of four motifs 6 are arranged register-accurate with respect to the corresponding cavities 5, with the result that a release signal 11 is already present for each of these. In contrast, the motifs 6′ are not arranged register-accurate with respect to the cavities 5 assigned to the motifs 6′, with the result that no release signal 12 is present here. Since not all release signals 11 have been generated, the control device 9 does not yet start the back injection molding process. The control device 9 preferably makes the further necessary alignment of the film web 1, with the result that the motifs 6′ are also arranged register-accurate with respect to the corresponding cavities 5.

As shown in FIG. 6b, all four motifs 6 are arranged register-accurate with respect to the corresponding cavities 5, with the result that a release signal 11 is present for all of them. The control device 9 detects the release signals 11 and starts the back injection molding process.

FIG. 7 shows a schematic view of a feed device 20.

With the feed device 20 shown in FIG. 7, two film webs 1, 1′ that are arranged next to one another in a direction substantially perpendicular to the feed direction and have motifs 6 are transported in the feed direction. The feed device 20 comprises two film pay-off reels 2, 2′ and two film take-up reels 3, 3′, wherein one film pay-off reel 2, 2′ and one film take-up reel 3, 3′ is assigned to each film web 1, 1′.

The feed device 20 is preferably formed in such a way that the two film webs 1, 1′ that are arranged next to one another can be provided, delivered and/or aligned independently of one another. A high register accuracy of the motifs 6 with respect to the cavities is hereby achieved for each film web 1, 1′. Thus, it is possible to react individually to motifs 6 of the film webs 1, 1′ that differ from each other and/or to different tolerances of the motifs 6 of the film webs 1, 1′. The register accuracy is hereby further increased.

However, it is also possible that the two film webs 1, 1′ that are arranged next to one another are provided, delivered and/or aligned synchronously.

Further, the feed device 20 shown in FIG. 7 has at least one adjustment device, in particular for the alignment of the two film webs 1, 1′ that are arranged next to one another. Advantageously, the feed device 20 has two adjustment devices, wherein in each case one adjustment device is assigned to one film web 1, 1′.

The adjustment device preferably comprises at least one stepper motor, in particular for the alignment of the two film webs 1, 1′ that are arranged next to one another or for the alignment of one of the two film webs 1, 1′ that are arranged next to one another. Advantageously, the adjustment device comprises a first and a second stepper motor, wherein the first stepper motor is formed for the alignment of one or both film webs 1, 1′ in the feed direction and the second stepper motor is formed for the alignment of one or both film webs 1, 1′ in a direction perpendicular to the feed direction.

Expediently, the stepper motor here has a minimum step size of 0.005 mm, preferably 0.001 mm. Further, it is expedient that the stepper motor has a maximum speed of 2000 mm/s. An efficient and precise alignment of the two film webs 1, 1′ that are arranged next to one another and have motifs 6 is hereby made possible.

Alternatively to the stepper motor, the adjustment device can also have a servomotor with a maximum speed of 2000 mm/s. A servomotor can position very precisely independently of a fixed step length, thus reach fixed positions, and/or react very precisely to control signals.

Further, it is also possible that the at least one adjustment device is part of the film pay-off reels 2, 2′ and/or of the film take-up reels 3, 3′.

The feed device 20 shown in FIG. 7 further has at least one sensor 8, in particular for detecting register marks 7, 7′ and/or motifs 6. With respect to the design and/or arrangement of the sensor 8, reference is made here to the above statement.

It is advantageous if the feed device 20 has at least one control device 9. The control device 9 of the feed device 20 is preferably designed to control the feed of the two film webs 1, 1′ that are arranged next to one another, in particular to control the feed independently of each other of the two film webs 1, 1′ that are arranged next to one another.

FIG. 8 shows a schematic top view onto a motif 6 of a film web 1. The motif 6 can be, for example, a graphically formed outline, a figural representation, an image, a visually recognizable design element, a symbol, a logo, a portrait, a pattern, an alphanumeric character, a text, a color design and the like.

The film web 1 has a motif-free area. The motif 6 is surrounded by the motif-free area. In particular, the motif-free area is in each case formed between the motifs 6 and the side edges of the film webs 1 and/or between the motifs. The motif-free area therefore preferably forms a frame, in particular a circumferential frame, around a respective motif 6. The width of the motif-free area is preferably between 10 mm and 550 mm, in particular between 25 mm and 300 mm.

As shown in FIG. 8, the motif-free area preferably has a first partial area 21 and a second partial area 22, wherein in particular the first partial area 21 makes space for the positioning of a clamping device, in particular a clamp frame, and/or the second partial area 22 makes space for the positioning of register marks.

As shown in FIG. 8, the first partial area 21 is arranged both directly adjacent to the motif 6 and also directly adjoining the motif 6. Fixing of the film webs by means of a clamping device is hereby achieved as close as possible to the motif 6, whereby interference factors such as film stretching, wrinkling etc. are minimized. As shown in FIG. 8, the second partial area 22 and the motif 6 are arranged spaced apart from each other. The first partial area 21 is arranged between motif 6 and second partial area 22. The register marks preferably arranged in the second partial area 22 can hereby be detected more easily by sensors or easier positioning of the sensors is possible.

The first partial area 21 preferably has a width between 5 mm and 500 mm, in particular preferably between 15 mm and 200 mm. The second partial area 22 preferably has a width between 5 mm and 50 mm, in particular preferably between 15 mm and 30 mm.

### LIST OF REFERENCE NUMBERS

1, 1′ film webs
2, 2′ film pay-off reels
3, 3′ film take-up reels
4 injection mold
5 cavity
6, 6′ motif
7, 7′ register marks
8 sensor
9 control device
10 system
11 release signal
12 no release signal
feed device
21, 22 partial areas
101, 102, 103,
201, 202, 203 steps

1. A method for processing film webs, by means of a feed device with a feed direction and an injection mold having at least two cavities, wherein the method comprises the following steps:
providing at least two film webs that are arranged next to one another in a direction substantially perpendicular to the feed direction and have motifs,
delivering the at least two film webs that are arranged next to one another into the injection mold,
aligning the at least two film webs that are arranged next to one another in such a way that each motif is arranged register-accurate with respect to a respective cavity.

2. The method according to claim 1, wherein the at least two film webs that are arranged next to one another are provided, delivered and/or aligned independently of one another.

3. The method according to claim 1, wherein the alignment and/or delivery of the at least two film webs that are arranged next to one another is effected in each case with the help of at least one register mark.

4. The method according to claim 1, wherein the alignment and/or delivery of the at least two film webs that are arranged next to one another is effected in each case with the help of at least one motif of each of the at least two film webs that are arranged next to one another.

5. The method according to claim 3, wherein the alignment of the at least two film webs that are arranged next to one another is effected with the help of a comparison of the position of the at least one register mark and/or the position of the at least one motif with the predetermined position of the cavities.

6. The method according to claim 1, wherein the injection mold has one or more further cavities in the feed direction, with the result that, for each of the at least two film webs that are arranged next to one another, several motifs are arranged register-accurate, simultaneously, with respect to a respective cavity.

7. The method according to claim 1, wherein the delivery and/or the alignment of the at least two films that are arranged next to one another comprises a first and/or a second phase, wherein the phases differ from each other the film transport average speed and/or film transport distance.

8. The method according to claim 7, wherein, in the first phase, the at least two film webs that are arranged next to one another are aligned at a higher film transport average speed and/or over a longer film transport distance than in the second phase.

9. The method according to claim 7, wherein, in the first phase the film transport average speed is between 1 mm/s and 1000 mm/s, and/or the film transport distance is between 10 mm and 5000 mm.

10. The method according to claim 7, wherein, in that in the second phase the film transport average speed is between 1 mm/s and 100 mm/s, and/or the film transport distance is between 3 mm and 50 mm.

11. The method according to claim 3, wherein the delivery and/or the alignment of the at least two films that are arranged next to one another comprises a first and/or a second phase, wherein the phases differ from each other in the film transport average speed and/or film transport distance, and wherein, when the at least one register mark and/or the at least one motif (6) is detected, there is a changeover from the first to the second phase.

12. The method according to claim 1, wherein, after register-accurate arrangement of each motif with respect to a respective cavity, the at least two film webs that are arranged next to one another are fixed by means of a clamp frame, and/or by means of vacuum suction.

13. The method according to claim 1, wherein, after register-accurate arrangement of each motif with respect to a respective cavity, a release signal is generated in each case.

14. The method according to claim 13, wherein, the method further comprises at least one of the following steps, which is carried out after generation of the release signals:
closing the injection mold
back injection molding the motifs, that are arranged register-accurate with respect to the cavities, of the at least two film webs that are arranged next to one another with a plastic compound at least in areas
opening the injection mold
peeling a carrier layer of the at least two film webs that are arranged next to one another off the back-injection-molded motifs
removing a molded plastic part

15. A feed device with a feed direction for feeding at least two film webs that are arranged next to one another in a direction substantially perpendicular to the feed direction and have motifs, comprising at least two film pay-off reels and at least two film take-up reels, wherein one film pay-off reel and one film take-up reel is assigned to each film web.

16. A feed device according to claim 15, wherein, the feed device is formed such that the at least two film webs that are arranged next to one another are provided, delivered and/or aligned independently of one another.

17. The feed device according to claim 15, wherein, the feed device has at least one sensor for detecting at least one register mark and/or at least one motif.

18. The feed device according to claim 17, wherein, the at least one sensor is a transmitted light and/or reflected light sensor.

19. The feed device according to claim 15, further comprising a control device for controlling the feed, independently of one another, of the at least two film webs that are arranged next to one another.

20. An injection mold for back injection molding at least two film webs having motifs, wherein, in top view, the film webs are arranged next to one another in a direction substantially perpendicular to a feed direction of the film webs, wherein the injection mold has at least two cavities.

21. The injection mold according to claim 20, wherein, in top view, the at least two cavities are arranged in a direction substantially perpendicular to the feed direction, such that at least one cavity is assigned to each film web.

22. The injection mold according to claim 20, wherein, the injection mold has one or more further cavities in the feed direction and/or wherein at least two cavities, which are arranged one behind the other in the feed direction, are assigned to each film web.

23. The injection mold according to claim 20, wherein, the cavities are arranged according to a one- or two-dimensional grid.

24. The injection mold (4) according to claim 23, wherein, the grid width in the feed direction is between 1 mm and 100 mm, and/or the grid width perpendicular to the feed direction is between 10 mm and 2000 mm.

25. The injection mold according to claim 20, further comprising a clamp frame, and/or vacuum suction.

26. A system comprising a feed device according to claim and an injection mold for back injection molding at least two film webs having motifs, wherein, in top view, the film webs are arranged next to one another in a direction substantially perpendicular to a feed direction of the film webs, wherein the injection mold has at least two cavities.

27. The system according to claim 26, further comprising at least one sensor for detecting at least one register mark and/or at least one motif.

28. The system according to claim 27, wherein the at least one sensor has a distance from at least one of the cavities between 5 mm and 200 mm.

29. The system according to claim 26, wherein the at least one sensor is arranged in such a way that it detects substantially edge areas of a film web, wherein, in top view, the areas in each case lie on a side of one film web facing away from the other film web.

30. The system according to claim 26, further comprising a control device.

31. The system according to claim 30, wherein, the control device controls the feed of the of the at least two film webs that are arranged next to one another and/or the injection mold.

32. The system according to claim 31, wherein, the control device is formed in such a way that the feed of the at least two film webs that are arranged next to one another is controlled independently of one another.

33. The system according to claim 26, wherein the control device is formed in such a way that, after register-accurate arrangement of each motif with respect to a respective cavity, the control device actuates the injection mold whereby the injection mold is closed.
